(19) United States
(12) Patent Application Publication
(10) Pub. No.: US 2011/0295522 A1
(43) Pub. Date: Dec. 1, 2011

(54) TIRE PRESSURE MONITORING

(75) Inventors: Michael Clark, West Midlands (GB); Trevor Chandler, West Midlands (GB)

(73) Assignee: Westley Plastics Limited, Birmingham, West Midlands (GB)

(21) Appl. No.: 13/146,129

(22) PCT Filed: Jan. 25, 2010
(86) PCT No.: PCT/GB2010/050105

§ 371 Date: Aug. 18, 2011

(30) Foreign Application Priority Data
Jan. 24, 2009 (GB) 0901158.6

(51) Int. Cl. G06F 19/00; B60C 17/04

(52) U.S. Cl. 702/33; 152/520

(57) ABSTRACT

The invention provides a run-flat device comprising a magnet. The run-flat device can be incorporated into a tyre condition monitoring system.

This invention relates to vehicle wheels that have inflatable tyres and to apparatuses and systems for monitoring the operating conditions of the same.

Tyre conditions, in particular tyre pressure, can affect vehicle safety and operating costs. For example, safety and operating costs will both be adversely affected when a tyre loses pressure and becomes deflated.

Traditionally, monitoring of tyre pressure was carried out manually using a conventional gauge at periodic intervals.

More recently, systems and apparatuses have been developed to remotely and/or continuously monitor tyre pressure. Such systems and apparatuses may allow information on tyre pressure to be reported to a vehicle user, e.g. thereby providing an instant alert of adverse pressure conditions and allowing the driver to take appropriate action to ensure vehicle, load and occupant safety. By monitoring and maintaining tyre pressures within pre-defined limits, tyre wear and road wear can be reduced and the safety of the vehicle, its load and occupants preserved.

One type of system for monitoring tyre pressure uses radio frequency (RF) to communicate information from pressure sensors mounted on the tyre valve to the user, e.g. driver.

However, RF-based systems are not suitable for use in a variety of situations, since RF transmissions can cause interference; they may act as a locating beacon for a vehicle and/or may cause deleterious events to occur, all of which may be undesirable WO 97/38870 discloses an apparatus which does not use RF. The apparatus comprises a magnet inside a wheel that will induce differing magnetic polarisation into the steel bracing in a tyre. When the tyre profile is wrong due to under-inflation, the magnet will be closer and the polarisation will differ. As the wheel rotates the moving magnet will make a non-rotating sensor, e.g. a magnetic pick-up coil, generate signals that are processed by suitable electronics to deduce the tyre status and if it differs from a pre-determined status, reports unsafe tyre conditions. Polarisation is then erased by another magnet housed with the sensor and the system is automatically reset to monitor the tyre status each revolution.

However, there are problems with the apparatus disclosed in WO 97/38870. First, in the case of catastrophic tyre failure, the magnet mounted on the wheel rim will be liable to being damaged. Secondly, the distance between the magnet and the steel bracings is relatively large, since the magnet is located close to the wheel rim, which may mean that a small decompression or over-compression of the tyre results in a vanishingly small signal that the sensor may not pick up. Thirdly, the use of the eraser magnet introduces operational complexity in a harsh environment. The vibration of each or all of the components can result in false signals or failure. It may also be difficult to arrange the components of this complex system into an effective configuration in situ.

A first aspect of the invention provides a run-flat device comprising at least one magnet.

A second aspect of the invention provides a tyre condition monitoring system comprising:
a wheel having a rim on which a run-flat device is fitted, the run-flat device comprising at least one magnet;
a tyre fitted to the wheel outside the run-flat device, the tyre comprising bracing elements, e.g. steel bracing elements; and
a sensing means, e.g. a fluxgate magnetometer, arranged to sense the magnetic field induced around the bracing elements by the or each magnet.

As used herein, the term “run-flat device” is to be understood to mean a device fitted on the rim of a wheel inside the tyre to enable the wheel to run with a deflated tyre.

With conventional wheels that are not fitted with run-flat devices, when the tyre becomes deflated, the tyre becomes damaged and can become shredded or thrown off the wheel rim, which is typically made from metal. This can cause the vehicle to which the wheel is fitted to lose control, thus endangering other road users. At best, the vehicle can be stopped and the wheel replaced with a spare wheel, or the puncture repaired, or a new tyre fitted to the existing wheel. For commercial vehicles, such as lorries, this is very time consuming and costly because of the need to acquire specialist breakdown or repair services to get the vehicle back on the move again.

With lorries, military vehicles, carriers, such as bullion carriers, security vehicles, or other vehicles where a puncture of a tyre effectively halts the vehicle, and exposes the vehicle to danger from an external threat, there is a need to be able to continue with the vehicle journey irrespective of the deflated tyre.

When a tyre deflates partially or completely, the effective diameter of the wheel with the deflated tyre becomes relatively smaller compared with the wheels with inflated tyres. Therefore, the frictional engagement of the deflated tyre on the road causes the peripheral speed of the deflated tyre to increase to match the peripheral speed of the inflated tyres.

Simultaneously, any differential gearbox in the transmission drive path to a wheel with a deflated tyre will divert torque away from the driven wheels that have inflated tyres to the wheel with the deflated tyre. This in turn causes rotation of the deflated tyre relative to the wheel, particularly where the wheel is a driven wheel.

Run-flat devices usually comprise an annular body on to which that part of the outer circumferential wall of the tyre that is in contact with the ground or road can contact. Typically, the run-flat device may be made principally from plastics materials, such as nylon.

The run-flat device may comprise an annular body comprising a plurality of segments, e.g. two or three segments. The annular body may be made in two parts that are clamped to the outer rim of the wheel.

Typically, the annular body is designed to slip circumferentially on the metal rim when the tyre deflates. This slippage is important because it allows the tyre to slip on the wheel rim whilst ensuring little or no slippage of the tyre relative to the outer circumference of the annular body.

The annular body may comprise two semi-circular segments that are pivotally connected together at each end by a single clamping bolt that clamps the two segments together. Radial clamping of the segments onto the metal wheel may be achieved by a cylindrical band extending around the circumference of the segments that can be tightened to pull the segments together prior to tightening the pivot bolts. In this case, the pivotal connection at one end of the segments may have an elongate slot through which the clamping bolt passes that allows circumferential movement of the segments relative to each other during clamping them onto the rim of the metal wheel. The bolt may be accessible for tightening from only one side of the segments.

Typically, tyres contain metal bracing elements extending around their circumference within their road-contacting portion, which is sometimes termed the crown. The side walls of the tyre typically will not contain bracing elements. The bracing elements typically are made from steel, because it is sufficiently strong and relatively cheap. However, it will be appreciated that if another material were to be used instead of steel, the present invention would still work, provided that a magnetic field could be induced within the alternative material.

Without wishing to be constrained by any particular theory, it will be appreciated that the distance between the or each magnet and the steel bracing will change with the extent of the inflation of the tyre. Hence, the strength of the induced magnetic field will vary as the distance varies. Accordingly, deviations in the output derived from the magnet field from a pre-determined reference value or range can be used to provide a vehicle user with information concerning the state of the tyre, e.g. whether it is over-inflated or under-inflated.

The sensing means may be located, e.g. fixed, at a site a distance, e.g. up to 1 m, away from the tyre. For example, the sensing means may be housed within the wheel arch of a vehicle.

In preferred embodiments, the sensing means may be directional. For example, the sensing means may be substantially unidirectional. The sensing means may be “aimed” at a specific area, e.g. around the area where the tyre contacts the road or an area of the tyre at about the height of the wheel axle. Preferably, in use, the sensing means may be pointed at a side wall of the tyre.

Preferably, the sensing means, e.g. magnetometer, may be operably connected to a processing unit to interpret the reading therefrom. The processing unit may be connected to a display and/or other information-providing means such as a speaker to provide a user, e.g. a driver, with up-to-date tyre condition information and/or alert him to any problems, which may necessitate his slowing down or stopping to perform repairs.

Preferably, the magnetometer may comprise a fluxgate magnetometer. The fluxgate magnetometer may employ a sensing element comprising a rod core or a ring core.

In preferred embodiments, the sensing element, e.g. rod, ring or coil, may be located within a protective housing or casing, e.g. a sponge body.

The or each magnet may be a permanent magnet or an electromagnet. The magnet may be mounted on, fixed to or embedded in a surface of the run-flat device. The magnet may be housed within a bore or a cavity.

Preferably, the magnet may comprise NdFeB. Suitably, the magnet may have a surface Gauss of around 4500.

Preferably, the magnet may be located within a bore drilled through the run-flat device from one side to the other, the opening at one end being narrower than the other, with a step in the bore relatively close to the narrower end.

The magnet may be cylindrical and may be inserted into the bore from the wider end such that it sits on the step. The magnet may be held in place by adhesive. Preferably, the bore may be filled from its wider end, i.e. “behind” the magnet. The narrower opening may provide a window on to the magnet.

The bore may be circular in cross-section. For example, the wider opening may have a diameter of 20 mm and the narrower opening may have a diameter of 19 mm.

A cylindrical magnet, e.g. an NdFeB magnet, having a diameter of 20 mm and a height of 10 mm may be housed within the bore.

Preferably, the magnet may be located away from the tyre-bearing surface of the run-flat device, e.g. on or within a side surface, within a cavity or within a bore. Advantageously, therefore, the magnet may be sheltered or protected from damage in the event of a catastrophic tyre failure.

Further, by providing the magnet on a run-flat device, the distance between the magnet and the bracing elements may be relatively short, e.g. as compared with systems in which the magnet is mounted on the wheel rim. Accordingly, for a given magnet, the field induced around the bracing elements will be greater, thereby aiding detection of the field and changes therein.

As an alternative or in addition to the magnet, the run-flat device may comprise other sensing and/or communication devices.

For instance, the run-flat device may comprise direct pressure or temperature sensing means which may be operably connected to a radio frequency chip for communicating the readings from these sensing means to a user, e.g. a driver.

The run-flat device may comprise means for sensing distance travelled, e.g. by measuring the number of revolutions made by a wheel to which it is fixed.

A third aspect of the invention provides a system for measuring and/or monitoring the pressure within a tyre comprising:
a wheel to which the tyre is fitted, the tyre comprising bracing elements, e.g. steel bracing elements;
a magnet; and
a magnetometer, preferably a fluxgate magnetometer, arranged to detect the magnetic field induced by the permanent magnet around the bracing elements.

A fourth aspect of the invention provides a method of measuring and/or monitoring the pressure within a tyre comprising:
using a magnet to induce a magnetic field around the bracing elements of the tyre; and
detecting the induced magnetic field using a magnetometer;
   characterised in that the permanent magnet is comprised within, e.g. fixed to, mounted on, embedded in or housed within, a run-flat device fitted around the rim of the wheel which bears the tyre.

In order that the invention may be more fully understood, it will now be described by way of example only, with reference to the accompanying drawings in which:

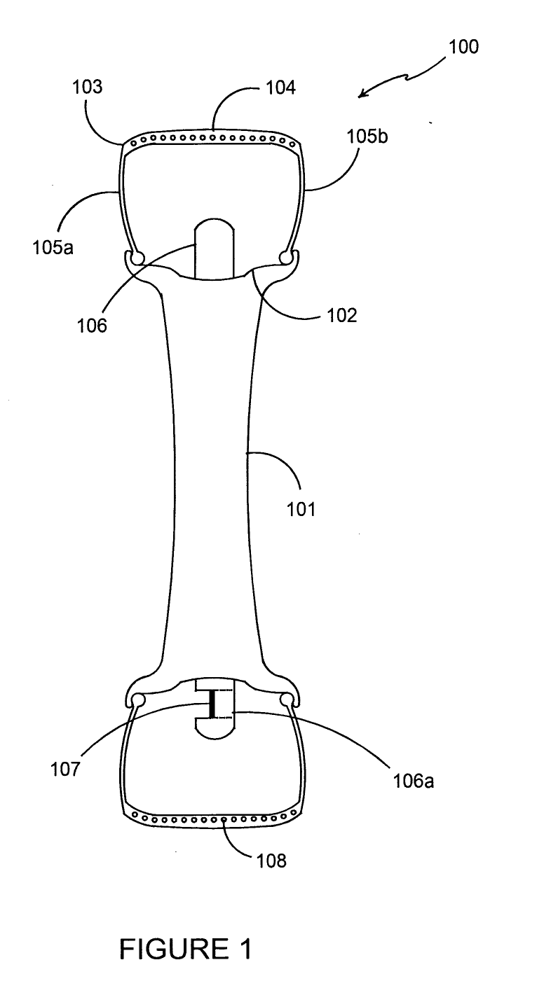

FIG. 1 shows in vertical cross-section a wheel fitted with a run-flat device according to the present invention.

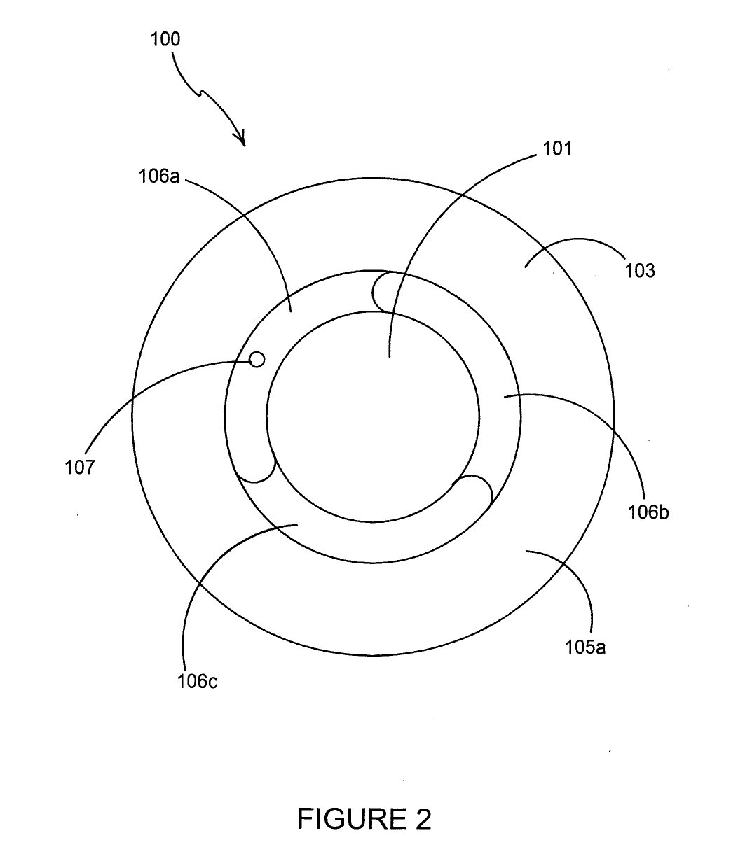

FIG. 2 shows a horizontal cross-section of the wheel shown in FIG. 1.

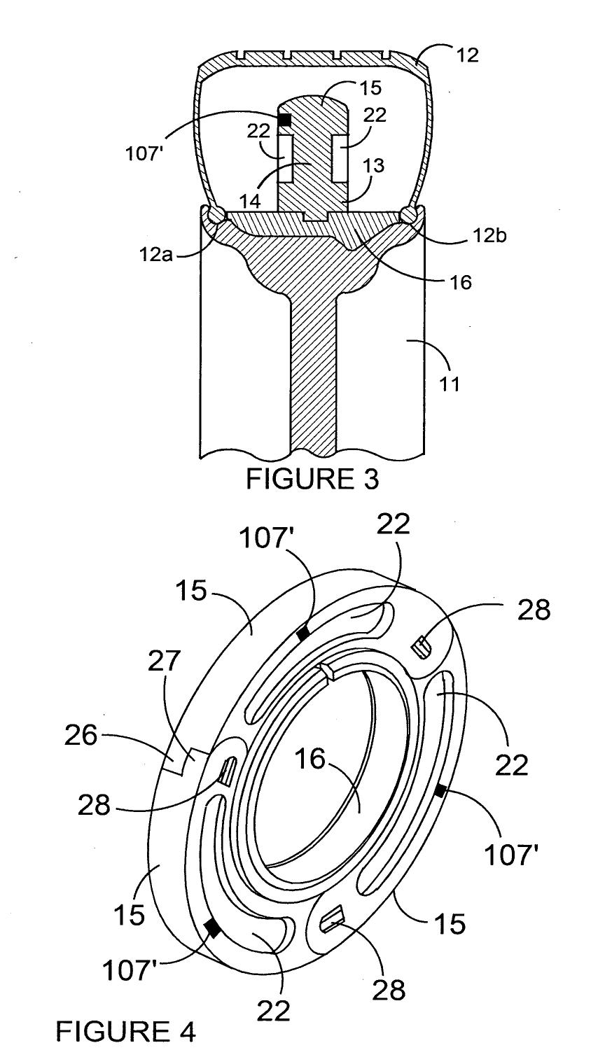

FIG. 3 shows a cross-sectional view through a wheel fitted with a run-flat device incorporating the present invention;

FIG. 4 is a side elevation showing a segmented ring and inner sleeve of the run-flat device of FIG. 3;

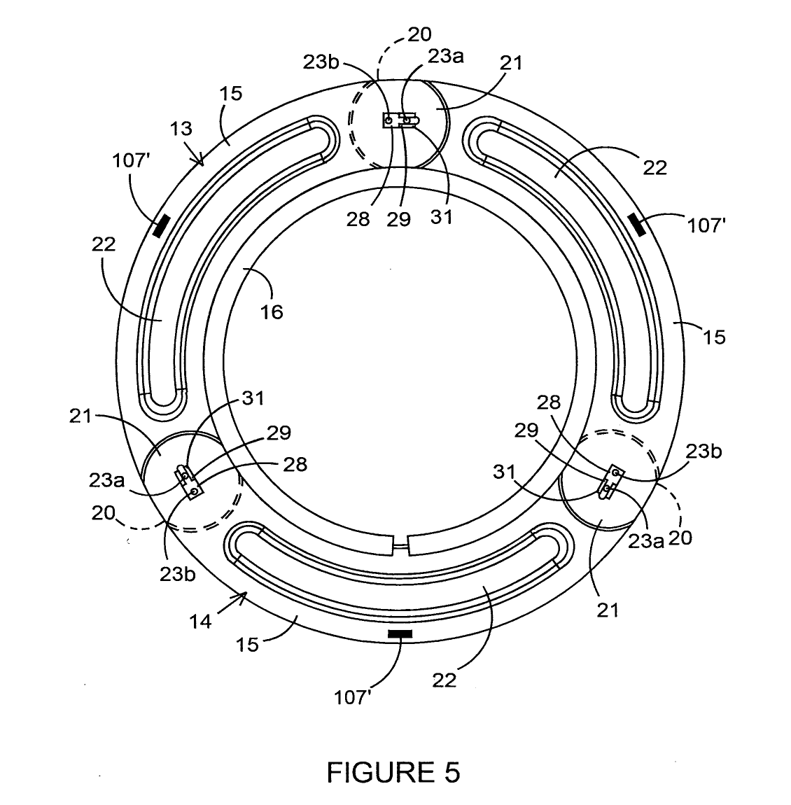

FIG. 5 is a schematic perspective view of the run-flat device in FIG. 3;

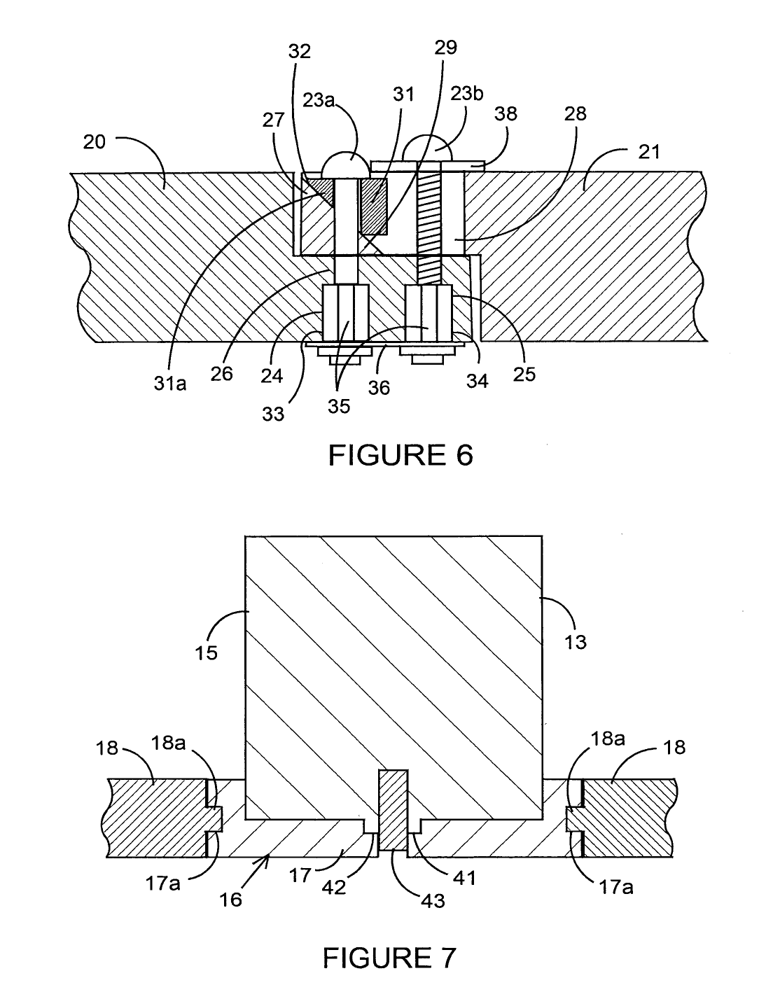

FIG. 6 shows a cross sectional view through the ends of two adjacent segments of the run-flat device of FIG. 4 and shows in greater detail the clamping means;

FIG. 7 shows a schematic cross-sectional view of an inner sleeve of the run-flat device of FIG. 4;

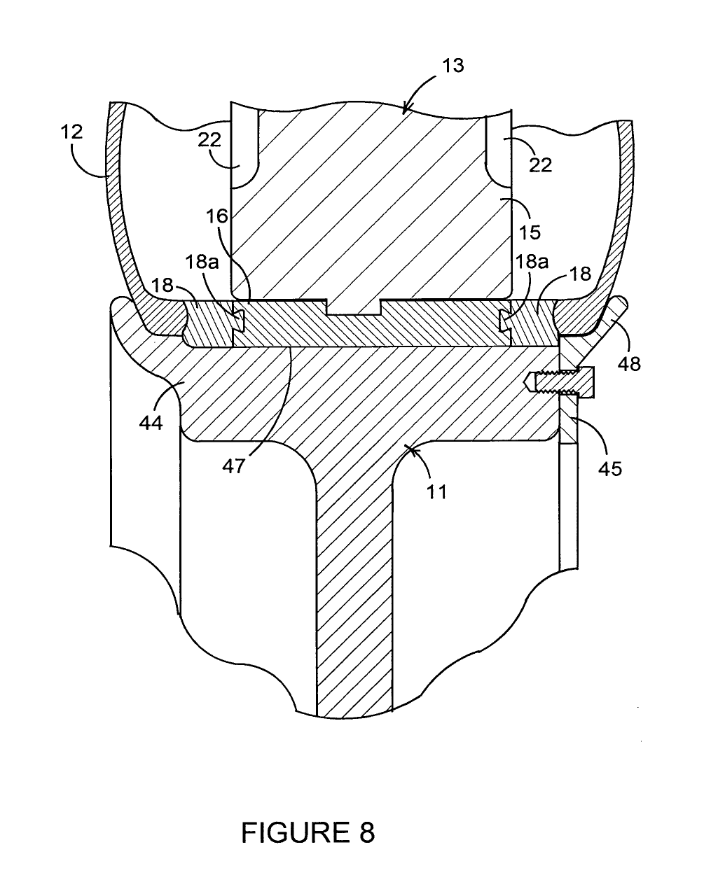

FIG. 8 shows a run-flat device of FIGS. 3 to 7 fitted to a two part wheel;

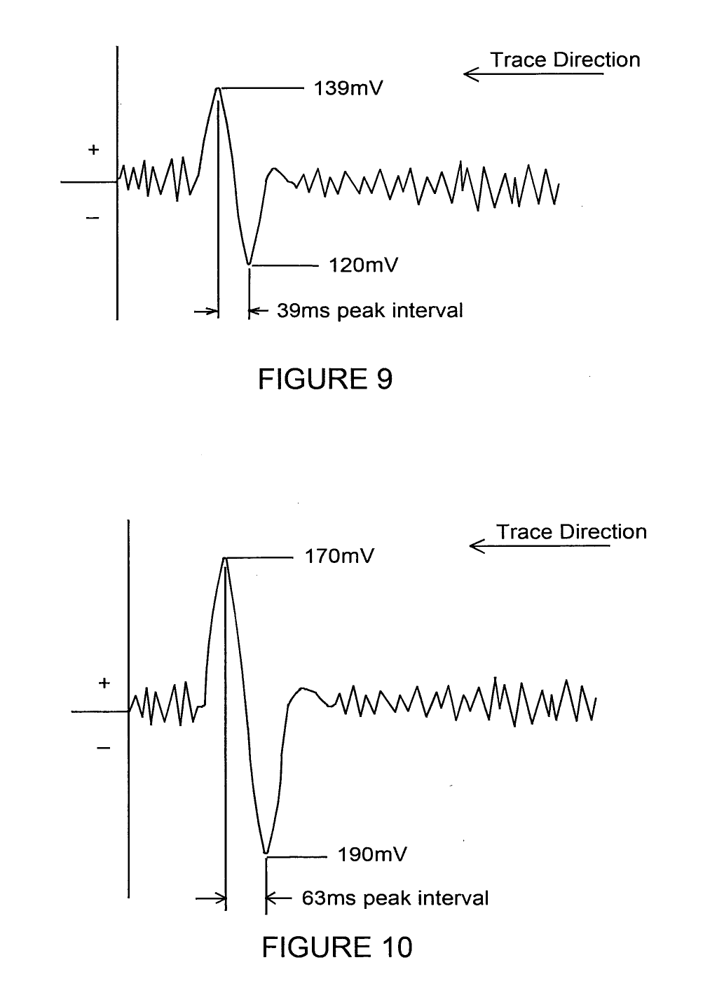

FIG. 9 shows an oscilloscope trace for a tyre under normal running conditions;

FIG. 10 shows an oscilloscope trace for a tyre which is running flat.

Referring to FIGS. 1 and 2, there is shown schematically a wheel assembly 100 for a vehicle such as a lorry. The wheel assembly 100 comprises a metal wheel 101, which can be attached to a wheel hub (not shown) of a vehicle (not shown).

The wheel 101 has a rim 102 around which is fixed a run-flat device 106.

A tyre 103 is fitted to the rim 102, thereby defining an interior volume in which the run-flat device 106 is located.

The tyre 103 has side walls 105 and a crown 104. The crown 104 contains steel bracing elements 108, which extend around the circumference of the tyre 103, thereby strengthening the tyre 103.

As can be seen in FIG. 2, the run-flat device 106 comprises an annular body made up of three segments 106a, 106b and 106c.

In one of the segments 106a, there is a permanent magnet 107. The permanent magnet 107 is housed within a bore passing through the run-flat device 106 about half-way along the length of the segment 106a. The bore has a narrower end which provides a window on to the magnet 107. The thicker end of the bore is filled with adhesive to keep the magnet 107 in place.

As will be appreciated from FIG. 1, the magnet 107 is located away from the crown-facing surface of the segment 106a of the run-flat device 106 in which it is housed. Further, it is located below the outer surface of the segment 106a. Hence, the magnet may be protected from major damage in the case of a catastrophic tyre failure.

Referring to FIG. 3, there is shown schematically a cross-section through a wheel assembly of a lorry. The wheel assembly 10 comprises a metal wheel 11 that is constructed so as to be capable of being fixed to a wheel hub of a vehicle (not shown), by way of conventional studs and nuts (not shown), or threaded studs (not shown). An inflatable tyre 12 is mounted on the rim of the metal wheel in a conventional manner. The metal wheel is of a single piece construction of the type in widespread use, and is provided with a conventional inflation valve (not shown). The metal wheel could be made of a well-known two-part construction that has a removable rim as shown in FIG. 8. Alternatively, the wheel may have a one-part construction.

Mounted on the rim of the wheel 11, inside the tyre 12 is a run-flat device 13 comprising an annular body 14, made of three nylon segments 15 that are either clamped directly to the outer diameter of the wheel rims, or, as may be preferred, are clamped to the outer circumference of an inner sleeve 16 that is split so as to permit the inner sleeve 16 to be opened and snapped in place around the outer diameter of the wheel 11. The inner sleeve 16 is made of nylon, but it could be constructed with a nylon central band 17 and polyurethane edge bands 18 as shown in FIG. 7. The central band has a dove-tail shaped recess 17(a) on each side face and the polyurethane side bands 18 each have a dove-tail shaped side member 18(a) that fits onto one of the recesses 17(a). The central band 17 provides rigidity to resist side-loads of the side walls as they collapse inwards whilst the polyurethane side bands 18 provide rigidity with slightly more flexibility or resilience than the nylon central band 17 to cushion the contact between the beads of the side-walls of the tyre 12 to avoid damage to the tyre 12 when the tyre deflates.

The outer circumference of the central band 17 has a recess 41 and the inner circumference of the segments 15 have a flange 42 that locates in the recess 41. A lubricant may be provided between the outer circumference of the inner sleeve 16 and the inner circumference of the segments 15.

It will be appreciated that at high rim speeds, the run-flat device 13 is subject to centripetal and centrifugal forces which tend to loosen the circumferential grip of the run-flat device 13 on the metal wheel 11. A shear pin 43 may be provided (as shown in FIG. 7) for each segment 15 to accommodate this radial movement whilst restraining the segments 15 circumferentially until the pins 43 are sheared by the deflated tyre contacting the segments 15 and causing the segments 15 as a complete ring to rotate.

The shear pin 43 is inserted through a hole in the central part of the rim of the wheel and through the inner sleeve 16.

The inner circumference of the inner sleeve 16 may be profiled to match the profile of a specific metal wheel, or could imply bridge across the recesses or wells of the metal wheel 11 between the surface 12 (a), 12(b) on which the beads of the side walls of the tyre 12 sit. The inner sleeve 16 must be shaped so as not to impede the fitting of the tyre because it is necessary to provide gaps or circumferential recesses that allow each side wall of the tyre 12 to fit as the tyre is slipped over the front rim of the metal wheel 11 prior to inflation. The inner sleeve 16 functions as a tyre bead retainer that stops the sidewalls of the tyre 12 collapsing inwards when the tyre is deflated.

Referring now to FIG. 8, there is shown a second type of metal wheel 11 fitted with a run-flat device 13 of the present invention. In this design of wheel, the metal wheel 11 is in two parts 44 and 45. The main part 44 of the wheel constitutes the rear rim 46 and central rim 47 of the wheel 11 on to which the rear wall of the tyre 12 is fitted and the second part 45 constitutes the front rim 48 that retains the front side wall of the tyre 12. The second part 45 is bolted to the main part 44 of the wheel prior to inflation of the tyre 12. The run-flat device 13 is of a similar construction to that described and shown in FIGS. 4 to 7.

It will be appreciated that the inner sleeve 16 shown in FIG. 3 effectively blocks off the deep wells formed in the rim of the metal wheel and serves to stop the side walls of the tyre falling into the deep wells when the tyre deflates. Clearly, in those designs of metal wheel that do not have deep wells and those that have cylindrical or slightly conical central rims with in-built bead retaining features (such as for example similar to that shown in FIG. 8), the inner sleeve 16 may be dispensed with but in this case a bead retaining device may be needed or the inner periphery of the segments modified to form a bead retaining device. We prefer to keep the inner sleeve 16 as the bead retainer.

Referring in greater detail to FIGS. 4 and 5, the three segments 15 are symmetrical about a radial plane orthogonal to the axis of rotation of the wheel and are of identical shape whether for a left-hand wheel or a right-hand wheel. Each segment is a segment of a hollow cylinder with a concave end 20 and a convex end 21. The convex ends 21 are of a complementary shape to the concave ends 20 so that the convex end 20 of each segment 15 nestles into the concave end 21 of an adjacent segment 15. The segments 15 are assembled inside the tyre 12 with the convex ends 21 constituting the leading edge relative to the direction of rotation of the tyre 12 when it is running wholly deflated. Each segment 15 has an arcuate recess 22 on each side to lighten the segments.

Each of the segments 15 comprises at a point roughly mid-way along its length and radially outside the arcuate recess 22 a cavity in which is housed a permanent magnet 107′.

In place of or as well as the permanent magnets 107′, one or more of the segments may be provided with direct temperature or pressure sensing means or means to measure distance of travel, which may be connected to a radio-frequency (RF) device to transmit additional tyre status information. The RF device may be passive or active. The RF device may emit a continuous or an intermittent signal. Means may be provided to turn off the RF device remotely, which may be especially advantageous in situations where an RF signal may inadvertently reveal the location of a vehicle to another party or may cause a deleterious event to occur.

As in the case of run-flat devices comprising one or more magnets, it is preferred for these other measuring and/or communication devices to be provided in protected locations, e.g. within a bore or cavity.

A permanent magnet need not be provided in each segment of the run-flat device. Ideally, the run-flat device may comprise only one magnet.

Further, the location of the permanent magnets may be varied, although locations removed from the ends of the segments may be preferred.

The permanent magnets may be located within the arcuate recesses 22.

At each end of the segments 51 there is provided a clamping means 23. In the form of two parallel bolts 23(a), 23(b). The shape of the ends of adjacent segments 15 and details of the clamping means is best seen in FIG. 5.

Referring to FIGS. 4, 5 and 6, the concave end 20 of each segment has a flange 26 of half the thickness of each segment and two circumferentially spaced holes 24, 25 are drilled through the flange 26. The holes 24 are of a slightly larger diameter than that of the bolts 23 (a) and 23(b) to allow relative movement of the end 20 relative to end 21. The convex end 21 of each segment has a flange 27 that overlaps the flange 26 in a circumferential direction. The flange 27 is provided with an elongate slot 28 that has inclined surfaces 29 that face away from the concave end 20 of the adjacent segment 15.

A wedge 31 having an inclined face 32 that abuts the inclined face 29 of the slot 28 in the convex end 21 of the segment 15 is placed in the slot 28 with the inclined face of the wedge 31 in contact with the inclined faces 29. The wedge 31 has a hole 31 (a) through which one of the dome-headed clamping bolts 23 (a) is passed. The ends 21 of the segments have two-spaced holes 33, 34 that align with the holes 24, 25 in ends 20. Two captive nuts 35 are mounted on a retaining plate 36 and the nuts 35 are inserted into the holes 33, 34 in the flanges 27. By tightening the first bolt 23(a) the wedge 31 urges the ends of the segments together in a circumferential direction. A second dome headed clamping bolt 23(b) is passed through a hole 37 in a clamping plate 38, through the slot 28 and holes 34 and screwed into the second captive nut 35.

The clamping plate 38 bridges the slot 28 and is shaped so as not to interfere with bolt 23 (a). When bolt 23(b) is tightened, the clamping plate 38 engages a side-wall of the segment (15) and pulls the two flanges 26, 27 axially together in a direction parallel to the axis of rotation of the wheel 11.

To fit the run-flat device 13, the rear side wall of the tyre 12 is levered on to the front rim of the metal wheel 11 and then the inner sleeve 16 is positioned to align with the inflation valve of the wheel (not shown). The rear wall of the tyre is then pushed over the sleeve 16 on to the rear rim. The segments 15 are inserted into the cavity of the deflated tyre from the front and are loosely assembled around the inner sleeve 16 with the heads of the bolts 23(a), 23(b) facing outwards. The wedges 31 are then tightened down by tightening the bolts 23(a) evenly, and this causes the wedges 31 to pull the segments 15 together and thereby clamp the segments 15 firmly to the inner sleeve 16 and clamp the inner sleeve 16 to the rim of the metal wheel 11. With the run-flat device 13 clamped on to the rim of the metal wheel 11, the bolts 23(b) are fully tightened to clamp the flanges 26 and 27 together axially. The outer sidewall of the tyre 12 is then levered over the front rim of the metal wheel 11 and the tyre 12 inflated.

In use, when the tyre 12 deflates, the tyre 12 collapses onto the outer circumferential surface of the run-flat device 13 in the region where the tyre 12 contacts the ground or road. This causes the run-flat device 13 to slip circumferentially on the rim of the metal wheel 11. This slippage between either the segments 15 and the rim of the metal wheel (where no inner sleeve 16 is fitted) or between the segments 15 and the inner sleeve 16 (where a sleeve 16 is fitted), ensures that there is little or no relative rotation between the tyre 12 and the run-flat device 13 and consequently little or no damage to the tyre 12. The beads of the sidewalls of the tyre 12 are prevented from collapsing inwards by the inner sleeve 16 that acts as a bead retainer when the tyre deflates.

It will be appreciated that at high rim speeds, the run-flat device 13 is subject to centripetal and centrifugal forces, which, in the absence of the second bolt 23(b) would loosen the circumferential grip of the run-flat device 13 on the metal wheel 11 by allowing the segments 15 to pivot relative to each other. By using two parallel bolts 23(a), 23(b) pivotal movement of the segments relative to each other is restricted or prevented. The bolts 23(a), 23(b) also provide both clamping in the circumferential direction and clamping in the axial direction (in a direction along the axis of rotation of the wheel) and prevent the segments twisting out of alignment with the wheel 11 when the deflated tyre contracts the outer circumference of the run-flat device 13.

### EXPERIMENTAL

In experiments, the applicant has used an FLC100 magnetic field sensor. This is an example of a miniature fluxgate magnetometer with high resolution for the measurement of weak magnetic fields up to 100 micro tesla.

A custom built rig was set up. The rig used a 750 W electric motor to drive a 15″ wheel through a steel shaft and spider coupling to simulate a road wheel rotating at approximately 12 mph. A tyre was fitted to the wheel. The rig incorporated an electronic variable speed control to change rotational speed and a mechanical device to simulate loss or gain of air/change in tyre cross section by increasing or decreasing the down force of the tyre onto a simulated road surface.

The fluxgate magnetometer was powered from a 5 V 2 mA DC supply and connected to an oscilloscope.

The rig was powered up through the electronic speed control set to 50 Hz and allowed to reach full rotational speed. At this point, the oscilloscope and fluxgate were powered up. The oscilloscope was set to display at 1 microvolt. The fluxgate was directed at the bottom of the rotating tyre at the point of contact with the simulated road surface and at a distance of 1 m. The oscilloscope display showed a number of signal peaks including one that corresponded with the magnet passing the ‘road surface’ position. This is shown in FIG. 9.

With the speed still set at 50 Hz, downward pressure was applied to the wheel/tyre using the mechanical device to simulate a loss of pressure equivalent to running flat. The observed oscilloscope signal corresponding to the magnet passing the bottom point increased in size, which equates to an increase in strength of flux. This is shown in FIG. 10.

Referring to FIGS. 9 and 10, the observed difference in the positive peak signals was around 31 mV and the difference in the negative peak signals was around 70 mV.

The applicant has found that the system according to the invention is capable of detecting changes in magnetic field which give rise to changes in the peak signal of around 10 mV, i.e. smaller variations in tyre pressure than between normal running conditions (FIG. 9) and running flat (FIG. 10).

In preferred embodiments of the invention, the signal derived from the strength of the induced magnetic field around the bracing elements is compared using a computer program with a pre-determined value or range for normal, i.e. safe and efficient, running conditions. This may be translated into a corresponding tyre pressure value, which may be communicated to the driver, e.g. via an in-cab display. The system may alert the driver, e.g. with a warning message on a display and/or via an audible signal, if the tyre conditions are outside the parameters for safe, efficient running of the vehicle.

1. A run-flat device comprising at least one magnet.

2. A run-flat device according to claim 1, wherein the at least one magnet is a permanent magnet or an electromagnet.

3. A run-flat device according to claim 1 comprising an annular body made up of two or three segments.

4. A run-flat device according to claim 1, which comprises a single magnet.

5. A run-flat device according to claim 1, wherein the at least one magnet is provided in a bore or a cavity formed in the device.

6. A run-flat device according claim 1, further comprising at least one of a direct sensing means, a data storage means and a communication means.

7. A run-flat device comprising at least one of a direct sensing means, a data storage means and a communication means.

8. A run-flat device according to claim 6, wherein the direct sensing means is a member selected from the group consisting of: a pressure sensor; a temperature sensor; and a means for measuring distance travelled.

9. A run-flat device according to claim 6, wherein the communication means comprises a radio frequency transmitter.

10. A tire condition monitoring system comprising a run-flat device comprising at least one magnet.

11. A tire condition monitoring system comprising:
a wheel having a rim on which a run-flat device is fitted, the run-flat device comprising at least one magnet;
a tire fitted to the wheel outside the run-flat device, the tire comprising bracing elements; and
a sensing means arranged to sense a magnetic field induced around the bracing elements by the at least one magnet.

12. A system according to claim 11, wherein the sensing means is a fluxgate magnetometer.

13. A system according to claim 11, in which the sensing means is aimed at or around a region of tire in contact with the ground.

14. A system according to claim 11, wherein the sensing means is operably connected to a processing unit.

15. A system according to claim 14, wherein the processing unit is operably connected to a means for providing a user with up-to-date tire condition information and/or to alert the user to any deterioration in a condition the tire.

16. (canceled)

17. A system for measuring and/or monitoring a pressure within a tire comprising: a wheel to which the tire is fitted, the tire comprising bracing elements; a magnet; and a magnetometer arranged to detect a magnetic field induced by the magnet around the bracing elements.

18. A method of measuring and/or monitoring a pressure within a tire comprising:
using a magnet to induce a magnetic field around bracing elements of the tire; and
detecting the induced magnetic field;
wherein the magnet is comprised within a run-flat device fitted around a rim of a wheel which bears the tire.

19. A run-flat device according to claim 7, wherein the direct sensing means is a member selected from the group consisting of: a pressure sensor; a temperature sensor; and a means for measuring distance travelled.

20. A run-flat device according to claim 7, wherein the communication means comprises a radio frequency transmitter.

21. A tire condition monitoring system comprising a run-flat device comprising at least one of a direct sensing means, a storage means and a communication means.
